(19) United States
(12) Patent Application Publication
(10) Pub. No.: US 2014/0233248 A1
(43) Pub. Date: Aug. 21, 2014

(54) CUP-SHAPED HEAT DISSIPATION MEMBER APPLICABLE IN ELECTRIC-POWERED LIGHT EMITTING UNIT

(71) Applicant: Tai-Her Yang, Dzan-Hwa (TW)

(72) Inventor: Tai-Her Yang, Dzan-Hwa (TW)

(21) Appl. No.: 13/961,928

(22) Filed: Aug. 8, 2013

Related U.S. Application Data
(63) Continuation-in-part of application No. 13/554,014, filed on Jul. 20, 2012.
Application No. 13/554,014 is a continuation-in-part of application No. 13/417,393, filed on Mar. 12, 2012.

(51) Int. Cl. F21V 29/00

(52) U.S. Cl. CPC F21V 29/2262
USPC 362/382

(57) ABSTRACT

The present invention provides a novel cup-shaped heat dissipater structure for meeting the heat dissipation requirement of an electric luminous body; the outer and/or inner surface of the cup-shaped heat dissipater (100) is served for accommodating the electric luminous body (200), so the heat generated by the electric luminous body (200) can be dissipated to the exterior from the surface of the heat dissipater, with the enlarged inner recessed surface formed on the cup-shaped structure in the heat dissipater (100) opposite to the installation location of the electric luminous body (200), the heat inside the heat dissipater (100) can also be directly dissipated through the larger heat dissipation area formed on the inner recessed surface of the cup-shaped structure, thereby assisting the electric luminous body (200) to dissipate heat to the exterior.

### CROSS REFERENCE TO RELATED APPLICATION

This is a Continuation-In-Part of application Ser. No. 13/554,014, filed on Jul. 20, 2012 which is a Continuation-In-Part of application Ser. No. 13/417,393, filed on Mar. 12, 2012.

### BACKGROUND OF THE INVENTION

(a) Field of the Invention

The present invention provides a novel cup-shaped heat dissipater structure for meeting the heat dissipation requirement of an electric luminous body, e.g. the heat dissipation requirement of a light emitting diode (LED) which is adopted as the electric luminous body (200); the outer and/or inner surface of the cup-shaped heat dissipater (100) is served for accommodating the electric luminous body (200), so the heat generated by the electric luminous body (200) can be dissipated to the exterior from the surface of the heat dissipater, with the enlarged inner recessed surface formed on the cup-shaped structure in the heat dissipater (100) opposite to the installation location of the electric luminous body (200), the heat inside the heat dissipater (100) can also be directly dissipated through the larger heat dissipation area formed on the inner recessed surface of the cup-shaped structure, thereby assisting the electric luminous body (200) to dissipate heat to the exterior.

(b) Description of the Prior Art

A conventional heat dissipation device applicable in the electric luminous body (200) of an electric illumination device, e.g. the heat dissipater used in a LED illumination device, usually transmits the heat generated by the LED to the heat dissipater then dissipates the heat to the exterior through the surface of the heat dissipater, thereby limiting the heat dissipation area.

### SUMMARY OF THE INVENTION

A conventional heat dissipation device applicable in the electric luminous body (200) of an electric illumination device, e.g. the heat dissipater used in a LED illumination device, usually transmits the heat generated by the LED to the heat dissipater then dissipates the heat to the exterior through the surface of the heat dissipater, thereby limiting the heat dissipation area; the present invention provides a novel cup-shaped heat dissipater structure for meeting the heat dissipation requirement of an electric luminous body, e.g. the heat dissipation requirement of a light emitting diode (LED) which is adopted as the electric luminous body (200); the outer and/or inner surface of the cup-shaped heat dissipater (100) is served for accommodating the electric luminous body (200), so the heat generated by the electric luminous body (200) can be dissipated to the exterior from the surface of the heat dissipater, with the enlarged inner recessed surface formed on the cup-shaped structure in the heat dissipater (100) opposite to the installation location of the electric luminous body (200), the heat inside the heat dissipater (100) can also be directly dissipated through the larger heat dissipation area formed on the inner recessed surface of the cup-shaped structure, thereby assisting the electric luminous body (200) to dissipate heat to the exterior.

### BRIEF DESCRIPTION OF THE DRAWINGS

FIG. 1 is a cross sectional view showing the basic structure of a conventional heat dissipater (100).

FIG. 2 is a top view of FIG. 1.

FIG. 3 is a cross sectional view illustrating the cup-shaped structure formed in the heat dissipater (100) opposite to the installation location of the electric luminous body (200) being formed with a single annular groove structure, according to the present invention.

FIG. 4 is a top view of FIG. 3.

FIG. 5 is a cross sectional view illustrating the cup-shaped structure formed in the heat dissipater (100) opposite to the installation location of the electric luminous body (200) being formed with a multiple annular groove structure, according to the present invention.

FIG. 6 is a top view of FIG. 5.

FIG. 7 is a cross sectional view of the first embodiment of the present invention illustrating the cup-shaped structure formed in the heat dissipater (100) opposite to the installation location of the electric luminous body (200) being formed with a single annular groove and a stepped structure having the higher tubular central column and the lower outer periphery.

FIG. 8 is a top view of FIG. 7.

FIG. 9 is a cross sectional view of the second embodiment of the present invention illustrating the cup-shaped structure formed in the heat dissipater (100) opposite to the installation location of the electric luminous body (200) being formed with a single annular groove and a stepped structure having the lower tubular central column and the higher outer periphery.

FIG. 10 is a top view of FIG. 9.

FIG. 11 is a cross sectional view of the third embodiment of the present invention illustrating the cup-shaped structure formed in the heat dissipater (100) opposite to the installation location of the electric luminous body (200) being formed with multiple annular grooves (104) and a multiple stepped structure having the higher tubular central column (103) and the lower outer periphery.

FIG. 12 is a top view of FIG. 11.

FIG. 13 is a schematic lateral view of the first embodiment of the present invention illustrating the upper periphery of the cup-shaped structure formed in the heat dissipater (100) opposite to the installation location of the electric luminous body (200) being formed with a crown-like tooth notch (105) and formed with a tubular central column (103).

FIG. 14 is a top view of FIG. 13.

FIG. 15 is another schematic lateral view of the second embodiment of the present invention illustrating the upper periphery of the cup-shaped structure formed in the heat dissipation member (100) opposite to the installation location of the electric-powered light emitting unit (200) being formed with multiple crown-like tooth notch (105) and a structure having the higher tubular central column (103) and the lower outer periphery.

FIG. 16 is a top view of FIG. 15.

FIG. 17 is a cross sectional view illustrating the heat dissipater (100) opposite to the installation location of the electric luminous body (200) being installed with a conical column member and the cup-shaped structure being formed as a fork-shaped annular structure, according to the present invention.

FIG. 18 is a top view of FIG. 17.

FIG. 19 is a schematic lateral view illustrating the top of the heat dissipater (100) opposite to the installation location of the electric luminous body (200) being additionally installed with a protection net (109), according to one embodiment of the present invention.

FIG. 20 is a schematic lateral view illustrating the top of the heat dissipater (100) opposite to the installation location of the electric luminous body (200) being installed with a top cover (110), and formed with a ventilation port (112) and a support column (111) served for combining and supporting between the top cover (110) and the heat dissipater (100), according to one embodiment of the present invention.

FIG. 21 is a schematic lateral view illustrating the support column (111) served for combining and supporting being installed between the top of the heat dissipater (100) opposite to the installation location of the electric luminous body (200) and the top cover (110), and the periphery of the ventilation port (112) being additionally installed with the protection net (109), according to one embodiment of the present invention.

### DESCRIPTION OF MAIN COMPONENT SYMBOLS

100: Heat dissipater
101: Annular surface of heat dissipater
102: Cup-shaped space
103: Tubular central column
104: Annular groove
105: Tooth notch
106: Fork-shaped annular structure
107: Multiple-plate type heat dissipation structure
108: Multiple-column type heat dissipation structure
109: Protection net
110: Top cover
111: Support column
112: Ventilation port
113: Through hole
200: Electric luminous body

### DETAILED DESCRIPTION OF THE PREFERRED EMBODIMENTS

A conventional heat dissipation device applicable in the electric luminous body (200) of an electric illumination device, e.g. the heat dissipater used in a LED illumination device, usually transmits the heat generated by the LED to the heat dissipater then dissipates the heat to the exterior through the surface of the heat dissipater, thereby limiting the heat dissipation area.

The present invention provides a novel cup-shaped heat dissipater structure for meeting the heat dissipation requirement of an electric luminous body, e.g. the heat dissipation requirement of a light emitting diode (LED) which is adopted as the electric luminous body (200); the outer and/or inner surface of the cup-shaped heat dissipater (100) is served for accommodating the electric luminous body (200), so the heat generated by the electric luminous body (200) can be dissipated to the exterior from the surface of the heat dissipater (100), with the enlarged inner recessed surface formed on the cup-shaped structure in the heat dissipater (100) opposite to the installation location of the electric luminous body (200), the heat inside the heat dissipater (100) can also be directly dissipated through the larger heat dissipation area formed on the inner recessed surface of the cup-shaped structure, thereby assisting the electric luminous body (200) to dissipate heat to the exterior.

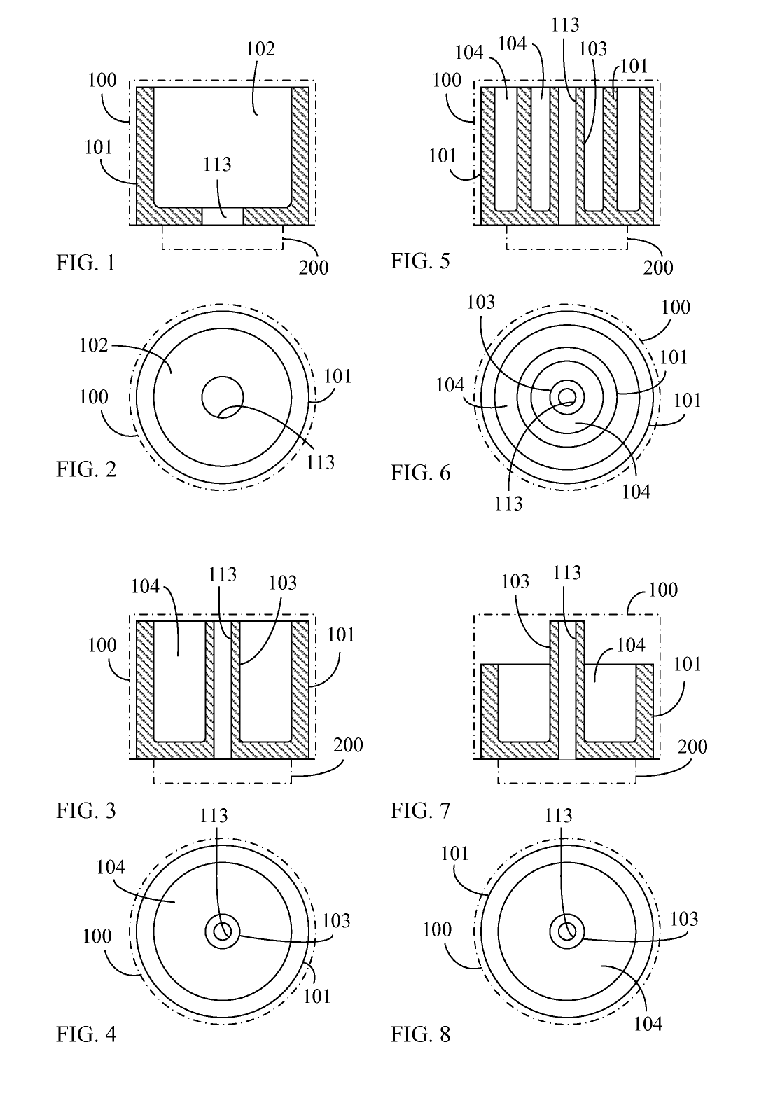

FIG. 1 is a cross sectional view showing the basic structure of a conventional heat dissipater (100);

FIG. 2 is a top view of FIG. 1;

As shown in FIG. 1 and FIG. 2, it mainly consists of:
heat dissipater (100): formed as a circular, oval or polygonal cup-shaped or cup-like structure, made of materials having great heat conductivity and heat dissipation property such as aluminum, copper and ceramic, integrally formed or assembled by plural pieces; including parallel or conical or reverse-conical cup body contours, and the cup bottom is provided with a through hole (113); the surface of one or both of the cup periphery and/or the inner annular surface of the heat dissipater (100) is formed as a planar or wavelike structure or formed as a structure having heat dissipation fins;

the outer and/or inner surface of the cup-shaped heat dissipater is served for accommodating the electric luminous body (200), so the heat generated by the electric luminous body (200) can be dissipated to the exterior from the surface of the heat dissipater, with the cup-shaped space (102) formed on the cup-shaped inner recessed structure opposite to the installation location of the electric luminous body (200), the heat inside the heat dissipater (100) can also be directly dissipated through the larger heat dissipation area formed on the inner recessed surface of the cup-shaped structure and via the convection by the through hole (113), thereby assisting the electric luminous body (200) to dissipate heat to the exterior.

FIG. 3 is a cross sectional view illustrating the cup-shaped structure formed in the heat dissipater (100) opposite to the installation location of the electric luminous body (200) being formed with a single annular groove structure, according to the present invention;

FIG. 4 is a top view of FIG. 3;

As shown in FIG. 3 and FIG. 4, it mainly consists of:
heat dissipater (100): formed as a circular, oval or polygonal cup-shaped or cup-like structure, made of materials having great heat conductivity and heat dissipation property such as aluminum, copper and ceramic, integrally formed or assembled by plural pieces; including parallel or conical or reverse-conical cup body contours; wherein one surface of the heat dissipater (100) is installed with the electric luminous body (200), and the other surface of the heat dissipater (100) is formed with the single annular groove (104) and a tubular central column (103) having a through hole (113); the surface of one or both of the cup periphery and/or the inner annular surface of the heat dissipater (100) is formed as a planar or wavelike structure or formed as a structure having heat dissipation fins;

the outer and/or inner surface of the cup-shaped heat dissipater is served for accommodating the electric luminous body (200).

FIG. 5 is a cross sectional view illustrating the cup-shaped structure formed in the heat dissipater (100) opposite to the installation location of the electric luminous body (200) being formed with a multiple annular groove structure, according to the present invention;

FIG. 6 is a top view of FIG. 5;

As shown in FIG. 5 and FIG. 6, it mainly consists of:
heat dissipater (100): formed as a circular, oval or polygonal cup-shaped or cup-like structure, made of materials having great heat conductivity and heat dissipation property such as aluminum, copper and ceramic, integrally formed or assembled by plural pieces; including parallel or conical or reverse-conical cup body contours; wherein one surface of the heat dissipater (100) is installed with the electric luminous body (200), and the other surface of the heat dissipater (100) is formed with two or more of the annular grooves (104) and the tubular central column (103) having a through hole (113) and two or more layers of the annular surfaces of heat dissipater (101); the surface of one or both of the cup periphery and/or the inner annular surface of the heat dissipater (100) is formed as a planar or wavelike structure or formed as a structure having heat dissipation fins;

the outer and/or inner surface of the cup-shaped heat dissipater is served for accommodating the electric luminous body (200).

FIG. 7 is a cross sectional view of the first embodiment of the present invention illustrating the cup-shaped structure formed in the heat dissipater (100) opposite to the installation location of the electric luminous body (200) being formed with a single annular groove and a stepped structure having the higher tubular central column (103) and the lower outer periphery;

FIG. 8 is a top view of FIG. 7;

As shown in FIG. 7 and FIG. 8, it mainly consists of:
heat dissipater (100): formed as a circular, oval or polygonal cup-shaped or cup-like structure, made of materials having great heat conductivity and heat dissipation property such as aluminum, copper and ceramic, integrally formed or assembled by plural pieces; including parallel or conical or reverse-conical cup body contours, wherein one surface of the heat dissipater (100) is installed with the electric luminous body (200), and the other surface of the heat dissipater (100) is formed with the single annular groove (104) and a higher tubular central column (103) having a through hole (113), thereby forming a stepped structure having the higher tubular central column (103) and the lower outer periphery; the surface of one or both of the cup periphery and/or the inner annular surface of the heat dissipater (100) is formed as a planar or wavelike structure or formed as a structure having heat dissipation fins;

the outer and/or inner surface of the cup-shaped heat dissipater is served for accommodating the electric luminous body (200).

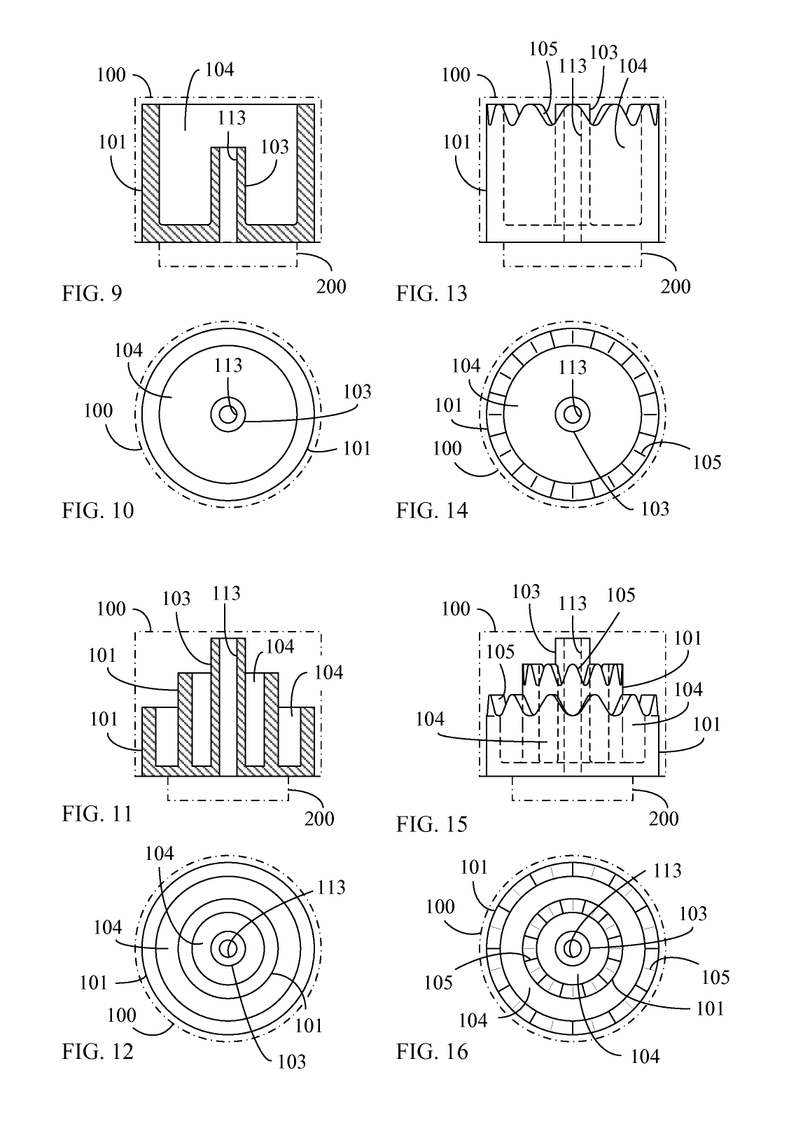

FIG. 9 is a cross sectional view of the second embodiment of the present invention illustrating the cup-shaped structure formed in the heat dissipater (100) opposite to the installation location of the electric luminous body (200) being formed with a single annular groove and a stepped structure having the lower tubular central column (103) and the higher outer periphery;

FIG. 10 is a top view of FIG. 9;

As shown in FIG. 9 and FIG. 10, it mainly consists of:
heat dissipater (100): formed as a circular, oval or polygonal cup-shaped or cup-like structure, made of materials having great heat conductivity and heat dissipation property such as aluminum, copper and ceramic, integrally formed or assembled by plural pieces; including parallel or conical or reverse-conical cup body contours, wherein one surface of the heat dissipater (100) is installed with the electric luminous body (200), and the other surface of the heat dissipater (100) is formed with the single annular groove (104) and a lower tubular central column (103) having a through hole (113), thereby forming a stepped structure having the lower tubular central column (103) and the higher outer periphery; the surface of one or both of the cup periphery and/or the inner annular surface of the heat dissipater (100) is formed as a planar or wavelike structure or formed with a structure having heat dissipation fins;

the outer and/or inner surface of the cup-shaped heat dissipater is served for accommodating the electric luminous body (200).

FIG. 11 is a cross sectional view of the third embodiment of the present invention illustrating the cup-shaped structure formed in the heat dissipater (100) opposite to the installation location of the electric luminous body (200) being formed with multiple annular grooves (104) and a multiple stepped structure having the higher tubular central column (103) and the lower outer periphery;

FIG. 12 is a top view of FIG. 11;

As shown in FIG. 11 and FIG. 12, it mainly consists of:
heat dissipater (100): formed as a circular, oval or polygonal cup-shaped or cup-like structure, made of materials having great heat conductivity and heat dissipation property such as aluminum, copper and ceramic, integrally formed or assembled by plural pieces; including parallel or conical or reverse-conical cup body contours, wherein one surface of the heat dissipater (100) is installed with the electric luminous body (200), and the other surface of the heat dissipater (100) is formed with two or more of the annular grooves (104) and the higher tubular central column (103) having a through hole (113), and two or more layers of the annular surfaces of heat dissipater (101), thereby forming a multiple stepped structure having the higher tubular central column (103) and the lower outer periphery; the surface of one or both of the cup periphery and/or the inner annular surface of the heat dissipater (100) is formed as a planar or wavelike structure or formed as a structure having heat dissipation fins;

the outer and/or inner surface of the cup-shaped heat dissipater is served for accommodating the electric luminous body (200);

the mentioned heat dissipater (100) further includes that the cup-shaped structure formed in the heat dissipater (100) opposite to the installation location of the electric luminous body (200) has two or more of the annular grooves (104) and the tubular central column (103) and two or more layers of the annular surfaces of heat dissipater (101), thereby forming a multiple-stepped structure having the higher outer periphery.

FIG. 13 is a schematic lateral view of the first embodiment of the present invention illustrating the upper periphery of the cup-shaped structure formed in the heat dissipater (100) opposite to the installation location of the electric luminous body (200) being formed with a crown-like tooth notch (105) and formed with a tubular central column (103);

FIG. 14 is a top view of FIG. 13;

As shown in FIG. 13 and FIG. 14, it mainly consists of:
heat dissipater (100): formed as a circular, oval or polygonal cup-shaped or cup-like structure, made of materials having great heat conductivity and heat dissipation property such as aluminum, copper and ceramic, integrally formed or assembled by plural pieces; including parallel or conical or reverse-conical cup body contours, wherein one surface of the heat dissipater (100) is installed with the electric luminous body (200), and the other surface of the heat dissipater (100) is formed the cup-shaped inner recessed structure having an annular structure formed with crown-like tooth notch (105) at the upper periphery and a tubular central column (103) having a through hole (113), and the tubular central column (103) and the annular structure formed with the crown-like tooth notch (105) at the periphery being at the same or different height; the surface of one or both of the cup periphery and/or the inner annular surface of the heat dissipater (100) is formed as a planar or wavelike structure or formed as a structure having heat dissipation fins;

the outer and/or inner surface of the cup-shaped heat dissipater is served for accommodating the electric luminous body (200);

the multiple annular structure of the mentioned multiple crown-like tooth notches (105) is defined as two or more layers.

FIG. 15 is another schematic lateral view of the second embodiment of the present invention illustrating the upper periphery of the cup-shaped structure formed in the heat dissipation member (100) opposite to the installation location of the electric-powered light emitting unit (200) being formed with multiple crown-like tooth notch (105) and a structure having the higher tubular central column (103) and the lower outer periphery;

FIG. 16 is a top view of FIG. 15;

As shown in FIG. 15 and FIG. 16, it mainly consists of:
heat dissipater (100): formed as a circular, oval or polygonal cup-shaped or cup-like structure, made of materials having great heat conductivity and heat dissipation property such as aluminum, copper and ceramic, integrally formed or assembled by plural pieces; including parallel or conical or reverse-conical cup body contours, wherein one surface of the heat dissipater (100) is installed with the electric luminous body (200), and the other surface of the heat dissipater (100) is formed with the cup-shaped inner recessed structure having the multiple crown-like tooth notch (105) at the upper periphery and a tubular central column (103) having a through hole (113), thereby forming a multiple annular structure having the higher tubular central column (103) and having the lower crown-like tooth notch (105) at the outer periphery; the surface of one or both of the cup periphery and/or the inner annular surface of the heat dissipater (100) is formed as a planar or wavelike structure or formed as a structure having heat dissipation fins;

the outer and/or inner surface of the cup-shaped heat dissipater is served for accommodating the electric luminous body (200);

the mentioned heat dissipater (100) further includes that the upper periphery of the cup-shaped structure formed in the heat dissipater (100) opposite to the installation location of the electric luminous body (200) has multiple crown-like tooth notches (105) and a tubular central column (103), thereby forming a structure having the lower tubular central column (103) and the higher multiple annular structure having the crown-like tooth notches (105) at the outer periphery;

the multiple annular structure of the mentioned multiple crown-like tooth notches (105) is defined as two or more layers.

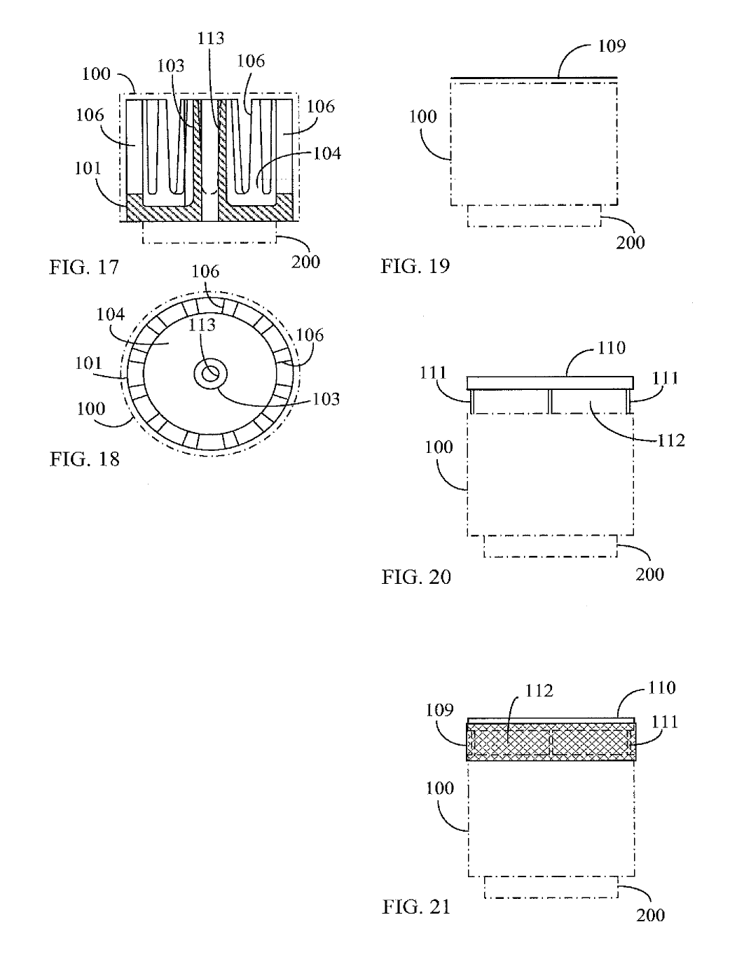

FIG. 17 is a cross sectional view illustrating the heat dissipater (100) opposite to the installation location of the electric luminous body (200) being installed with a conical column member and the cup-shaped structure being formed as a fork-shaped annular structure, according to the present invention;

FIG. 18 is a top view of FIG. 17;

As shown in FIG. 17 and FIG. 18, it mainly consists of:
heat dissipater (100): formed as a circular, oval or polygonal cup-shaped or cup-like structure, made of materials having great heat conductivity and heat dissipation property such as aluminum, copper and ceramic, integrally formed or assembled by plural pieces; including parallel or conical or reverse-conical cup body contours, wherein one surface of the heat dissipater (100) is installed with the electric luminous body (200), and the other surface of the heat dissipater (100) is formed with the cup-shaped inner recessed structure having the fork-shaped annular structure (106) and the conical tubular central column (103) having a through hole (113); the surface of one or both of the cup periphery and/or the inner annular surface of the heat dissipater (100) is formed as a planar or wavelike structure or formed as a structure having heat dissipation fins;

the outer and/or inner surface of the cup-shaped heat dissipater is served for accommodating the electric luminous body (200).

FIG. 19 is a schematic lateral view illustrating the top of the heat dissipater (100) opposite to the installation location of the electric luminous body (200) being additionally installed with a protection net (109), according to one embodiment of the present invention;

As shown in FIG. 19, according to one embodiment of the present invention, the top of the heat dissipater (100) opposite to the installation location of the electric luminous body (200) is additionally installed with the protection net (109).

FIG. 20 is a schematic lateral view illustrating the top of the heat dissipater (100) opposite to the installation location of the electric luminous body (200) being installed with a top cover (110), and formed with a ventilation port (112) and a support column (111) served for connecting and supporting between the top cover (110) and the heat dissipater (100), according to one embodiment of the present invention;

As shown in FIG. 20, according to one embodiment of the present invention, the top of the heat dissipater (100) opposite to the installation location of the electric luminous body (200) is installed with the top cover (110), and formed with the ventilation port (112) and the support column (111) served for connecting and supporting between the top cover (110) and the heat dissipater (100).

FIG. 21 is a schematic lateral view illustrating the support column (111) served for connecting and supporting being installed between the top of the heat dissipater (100) opposite to the installation location of the electric luminous body (200) and the top cover (110), and the periphery of the ventilation port (112) being additionally installed with the protection net (109), according to one embodiment of the present invention;

As shown in FIG. 21, according to one embodiment of the present invention, the support column (111) served for connecting and supporting is installed between the top of the heat dissipater (100) opposite to the installation location of the electric luminous body (200) and the top cover (110), and the periphery of the ventilation port (112) is additionally installed with the protection net (109).

The mentioned electric luminous body (200) according to the cup-shaped heat dissipation member applicable in electric-powered light emitting unit can be further configured by the electric luminous body and optical component and lampshade.

1. A cup-shaped heat dissipation member applicable in electric-powered light emitting unit, wherein the cup-shaped structure formed in the heat dissipater (100) opposite to the installation location of the electric luminous body (200) is formed with a single annular groove structure, and it mainly consists of:
heat dissipater (100): formed as a circular, oval or polygonal cup-shaped or cup-like structure, made of materials having great heat conductivity and heat dissipation property such as aluminum, copper and ceramic, integrally formed or assembled by plural pieces; including parallel or conical or reverse-conical cup body contours; wherein one surface of the heat dissipater (100) is installed with the electric luminous body (200), and the other surface of the heat dissipater (100) is formed with the single annular groove (104) and a tubular central column (103) having a through hole (113); the surface of one or both of the cup periphery and/or the inner annular surface of the heat dissipater (100) is formed as a planar or wavelike structure or formed as a structure having heat dissipation fins;
the outer and/or inner surface of the cup-shaped heat dissipater is served for accommodating the electric luminous body (200).

2. A cup-shaped heat dissipation member applicable in electric-powered light emitting unit as claimed in claim 1, wherein the cup-shaped structure formed in the heat dissipater (100) opposite to the installation location of the electric luminous body (200) is further formed with a multiple annular groove structure, and it mainly consists of:
heat dissipater (100): formed as a circular, oval or polygonal cup-shaped or cup-like structure, made of materials having great heat conductivity and heat dissipation property such as aluminum, copper and ceramic, integrally formed or assembled by plural pieces; including parallel or conical or reverse-conical cup body contours; wherein one surface of the heat dissipater (100) is installed with the electric luminous body (200), and the other surface of the heat dissipater (100) is formed with two or more of the annular grooves (104) and the tubular central column (103) having a through hole (113) and two or more layers of the annular surfaces of heat dissipater (101); the surface of one or both of the cup periphery and/or the inner annular surface of the heat dissipater (100) is formed as a planar or wavelike structure or formed as a structure having heat dissipation fins;
the outer and/or inner surface of the cup-shaped heat dissipater is served for accommodating the electric luminous body (200).

3. A cup-shaped heat dissipation member applicable in electric-powered light emitting unit as claimed in claim 1, wherein the cup-shaped structure formed in the heat dissipater (100) opposite to the installation location of the electric luminous body (200) is further formed with a single annular groove and a stepped structure having the higher tubular central column (103) and the lower outer periphery, and it mainly consists of:
heat dissipater (100): formed as a circular, oval or polygonal cup-shaped or cup-like structure, made of materials having great heat conductivity and heat dissipation property such as aluminum, copper and ceramic, integrally formed or assembled by plural pieces; including parallel or conical or reverse-conical cup body contours, wherein one surface of the heat dissipater (100) is installed with the electric luminous body (200), and the other surface of the heat dissipater (100) is formed with the single annular groove (104) and a higher tubular central column (103) having a through hole (113), thereby forming a stepped structure having the higher tubular central column (103) and the lower outer periphery; the surface of one or both of the cup periphery and/or the inner annular surface of the heat dissipater (100) is formed as a planar or wavelike structure or formed as a structure having heat dissipation fins;
the outer and/or inner surface of the cup-shaped heat dissipater is served for accommodating the electric luminous body (200).

4. A cup-shaped heat dissipation member applicable in electric-powered light emitting unit as claimed in claim 1, wherein the cup-shaped structure formed in the heat dissipater (100) opposite to the installation location of the electric luminous body (200) is further formed with a single annular groove and a stepped structure having the lower tubular central column (103) and the higher outer periphery, and it mainly consists of:
heat dissipater (100): formed as a circular, oval or polygonal cup-shaped or cup-like structure, made of materials having great heat conductivity and heat dissipation property such as aluminum, copper and ceramic, integrally formed or assembled by plural pieces; including parallel or conical or reverse-conical cup body contours, wherein one surface of the heat dissipater (100) is installed with the electric luminous body (200), and the other surface of the heat dissipater (100) is formed with the single annular groove (104) and a lower tubular central column (103) having a through hole (113), thereby forming a stepped structure having the lower tubular central column (103) and the higher outer periphery; the surface of one or both of the cup periphery and/or the inner annular surface of the heat dissipater (100) is formed as a planar or wavelike structure or formed with a structure having heat dissipation fins;
the outer and/or inner surface of the cup-shaped heat dissipater is served for accommodating the electric luminous body (200).

5. A cup-shaped heat dissipation member applicable in electric-powered light emitting unit as claimed in claim 2, wherein the cup-shaped structure formed in the heat dissipater (100) opposite to the installation location of the electric luminous body (200) is further formed with multiple annular grooves (104) and a multiple stepped structure having the higher tubular central column (103) and the lower outer periphery, and it mainly consists of:
heat dissipater (100): formed as a circular, oval or polygonal cup-shaped or cup-like structure, made of materials having great heat conductivity and heat dissipation property such as aluminum, copper and ceramic, integrally formed or assembled by plural pieces; including parallel or conical or reverse-conical cup body contours, wherein one surface of the heat dissipater (100) is installed with the electric luminous body (200), and the other surface of the heat dissipater (100) is formed with two or more of the annular grooves (104) and the higher tubular central column (103) having a through hole (113), and two or more layers of the annular surfaces of heat dissipater (101), thereby forming a multiple stepped structure having the higher tubular central column (103) and the lower outer periphery; the surface of one or both of the cup periphery and/or the inner annular surface of the heat dissipater (100) is formed as a planar or wavelike structure or formed as a structure having heat dissipation fins;
the outer and/or inner surface of the cup-shaped heat dissipater is served for accommodating the electric luminous body (200);
the mentioned heat dissipater (100) further includes that the cup-shaped structure formed in the heat dissipater (100) opposite to the installation location of the electric luminous body (200) has two or more of the annular grooves (104) and the tubular central column (103) and two or more layers of the annular surfaces of heat dissipater (101), thereby forming a multiple-stepped structure having the higher outer periphery.

6. A cup-shaped heat dissipation member applicable in electric-powered light emitting unit as claimed in claim 1, wherein the upper periphery of the cup-shaped structure formed in the heat dissipater (100) opposite to the installation location of the electric luminous body (200) is further formed with a crown-like tooth notch (105) and formed with a tubular central column (103), and it mainly consists of:
heat dissipater (100): formed as a circular, oval or polygonal cup-shaped or cup-like structure, made of materials having great heat conductivity and heat dissipation property such as aluminum, copper and ceramic, integrally formed or assembled by plural pieces; including parallel or conical or reverse-conical cup body contours, wherein one surface of the heat dissipater (100) is installed with the electric luminous body (200), and the other surface of the heat dissipater (100) is formed the cup-shaped inner recessed structure having an annular structure formed with crown-like tooth notch (105) at the upper periphery and a tubular central column (103) having a through hole (113), and the tubular central column (103) and the annular structure formed with the crown-like tooth notch (105) at the periphery being at the same or different height; the surface of one or both of the cup periphery and/or the inner annular surface of the heat dissipater (100) is formed as a planar or wavelike structure or formed as a structure having heat dissipation fins;
the outer and/or inner surface of the cup-shaped heat dissipater is served for accommodating the electric luminous body (200);
the multiple annular structure of the mentioned multiple crown-like tooth notches (105) is defined as two or more layers.

7. A cup-shaped heat dissipation member applicable in electric-powered light emitting unit as claimed in claim 5, wherein the upper periphery of the cup-shaped structure formed in the heat dissipation member (100) opposite to the installation location of the electric-powered light emitting unit (200) is further formed with multiple crown-like tooth notch (105) and a structure having the higher tubular central column (103) and the lower outer periphery, and it mainly consists of:
heat dissipater (100): formed as a circular, oval or polygonal cup-shaped or cup-like structure, made of materials having great heat conductivity and heat dissipation property such as aluminum, copper and ceramic, integrally formed or assembled by plural pieces; including parallel or conical or reverse-conical cup body contours, wherein one surface of the heat dissipater (100) is installed with the electric luminous body (200), and the other surface of the heat dissipater (100) is formed with the cup-shaped inner recessed structure having the multiple crown-like tooth notch (105) at the upper periphery and a tubular central column (103) having a through hole (113), thereby forming a multiple annular structure having the higher tubular central column (103) and having the lower crown-like tooth notch (105) at the outer periphery; the surface of one or both of the cup periphery and/or the inner annular surface of the heat dissipater (100) is formed as a planar or wavelike structure or formed as a structure having heat dissipation fins;
the outer and/or inner surface of the cup-shaped heat dissipater is served for accommodating the electric luminous body (200);
the mentioned heat dissipater (100) further includes that the upper periphery of the cup-shaped structure formed in the heat dissipater (100) opposite to the installation location of the electric luminous body (200) has multiple crown-like tooth notches (105) and a tubular central column (103), thereby forming a structure having the lower tubular central column (103) and the higher multiple annular structure having the crown-like tooth notches (105) at the outer periphery;
the multiple annular structure of the mentioned multiple crown-like tooth notches (105) is defined as two or more layers.

8. A cup-shaped heat dissipation member applicable in electric-powered light emitting unit as claimed in claim 1, wherein the heat dissipater (100) opposite to the installation location of the electric luminous body (200) is further installed with a conical column member and the cup-shaped structure being formed as a fork-shaped annular structure, and it mainly consists of:
heat dissipater (100): formed as a circular, oval or polygonal cup-shaped or cup-like structure, made of materials having great heat conductivity and heat dissipation property such as aluminum, copper and ceramic, integrally formed or assembled by plural pieces; including parallel or conical or reverse-conical cup body contours, wherein one surface of the heat dissipater (100) is installed with the electric luminous body (200), and the other surface of the heat dissipater (100) is formed with the cup-shaped inner recessed structure having the fork-shaped annular structure (106) and the conical tubular central column (103) having a through hole (113); the surface of one or both of the cup periphery and/or the inner annular surface of the heat dissipater (100) is formed as a planar or wavelike structure or formed as a structure having heat dissipation fins;
the outer and/or inner surface of the cup-shaped heat dissipater is served for accommodating the electric luminous body (200).

9. A cup-shaped heat dissipation member applicable in electric-powered light emitting unit as claimed in claim 1, wherein includes:
(a) the top of the heat dissipater (100) opposite to the installation location of the electric luminous body (200) is additionally installed with the protection net (109);
(b) the top of the heat dissipater (100) opposite to the installation location of the electric luminous body (200) is installed with the top cover (110), and formed with the ventilation port (112) and the support column (111) served for connecting and supporting between the top cover (110) and the heat dissipater (100);
(c) both (a) and (b) are installed.
